(19) United States
(12) Patent Application Publication
(10) Pub. No.: US 2009/0148802 A1
(43) Pub. Date: Jun. 11, 2009

(54) PROCESS FOR HEATING A FLUID AND AN INJECTION MOLDED MOLDING

(76) Inventors: Jan Ihle, Deutschlandsberg (AT); Werner Kahr, Deutschlandsberg (AT)

Correspondence Address: FISH & RICHARDSON PC, P.O. BOX 1022, MINNEAPOLIS, MN, 55440-1022, US

(21) Appl. No.: 11/950,659

(22) Filed: Dec. 5, 2007

(51) Int. Cl. B29C 33/04

(52) U.S. Cl. 432/29; 428/34.4

(57) ABSTRACT

A process for heating a fluid includes providing an injection molded molding made of a ceramic material with a positive temperature coefficient containing less than 10 ppm of metallic impurities, and using the injection molded molding to heat a fluid. For a straight line through the injection molded molding, at least two cross sectional areas perpendicular to the line cannot be superimposed on each other via a translation along the line,

[symbol]

### CROSS-REFERENCE TO RELATED APPLICATIONS

The following patent applications, all of which were filed on the same day as this patent application, are hereby incorporated by reference into this patent application as if set forth herein in full: (1) U.S. patent application Ser. No. ______, entitled “Injection Molded PTC-Ceramics”, Attorney Docket No. 14219-186001, Application Ref. P2007,1179USE; (2) U.S. patent application Ser. No. ______, entitled “Feedstock And Method For Preparing The Feedstock”, Attorney Docket No. 14219-187001, Application Ref. P2007,1180USE; (3) U.S. patent application Ser. No. ______, entitled “Mold Comprising PTC-Ceramic”, Attorney Docket No. 14219-184001, Application Ref. P2007,1181USE; (4) U.S. patent application Ser. No. ______, entitled “Injection Molded Nozzle And Injector And Injector Comprising The Injection Molded Nozzle”, Attorney Docket No. 14219-183001, Application Ref. P2007,1183USE; and (5) U.S. patent application Ser. No. ______, entitled “PTC-Resistor”, Attorney Docket No. 14219-185001, Application Ref. P2007,1184USE.

### TECHNICAL FIELD

This disclosure relates to a process of heating fluids using a ceramic PTC heater. The abbreviation PTC stands for Positive Temperature Coefficient. These are therefore heaters which, at least within a limited temperature interval, have a positive temperature coefficient of the electrical resistance. This disclosure also relates to an injection molded molding.

### BACKGROUND

Ceramic PTC heaters for heating fluids are in general made in the form of compressed pills or simple geometrical structures like a cube. The ceramic PTC element is placed inside a tube for heating the fluid which passes along the PTC element. The ratio of the volume to the heating surface of these simple geometrical ceramic PTC structures was found to be insufficient for certain applications.

### SUMMARY

By using non simple structures entirely made of ceramic PTC material for heating fluids such as gases or liquids advantages can be obtained. Complex geometrical forms which cannot be formed by compression or extrusion molding can be formed by injection molding. Injection molded structures obtain for every straight line through the injection molded molding at least two cross sectional areas perpendicular to this line, which cannot be accommodated on each other by a translation along this line.

In contrast, geometrical structures formed by extrusion molding comprise one line through the structure, whereby the whole structure comprises the same cross-section along this line.

It is therefore not possible to obtain a geometrical structure by extrusion molding which comprises a section which can not be formed by extrusion through a die.

The feedstock used for injection molding comes in the form of granules. These granules contain powdered ceramic material comprising BaTiO₃ together with an organic binder. The feedstock is melted at high pressure into a mold, which is the inverse shape of the product's shape.

The injection moldable feedstock may comprise a ceramic filler, a matrix for binding the filler and a content of, e.g., less than 10 ppm of metallic impurities.

The ceramic may for example be based on Bariumtitanate (BaTiO₃), which is a ceramic of the perovskite-type (ABO₃).

For the injection molding process a feedstock could be used comprising a ceramic filler, a matrix for binding the filler and a content of less than 10 ppm of metallic impurities. One possible ceramic filler can be denoted by the structure:

Ba_{1-x-y}MₓD_{y}Ti_{1-a-b}NₐMn_{b}O₃

wherein the parameters are x=0 to 0.5, y=0 to 0.01, a=0 to 0.01 and b=0 to 0.01. In this structure M stands for a cation of the valency two, like for example Ca, Sr or Pb, D stands for a donor of the valency three or four, for example Y, La or rare earth elements, and N stands for a cation of the valency five or six, for example Nb or Sb. Thus, a high variety of ceramic materials can be used wherein the composition of the ceramic may be chosen in dependency of the required electrical features of the later sintered ceramic.

The ceramic filler of the feedstock is convertible to a PTC-ceramic with low resistivity and a steep slope of the resistance-temperature curve. The resistivity of a PTC-ceramic made of such a feedstock can comprise a range from 3 Ωcm to 30000 Ωcm at 25° C. in dependence of the composition of the ceramic filler and the conditions during sintering the feedstock. The characteristic temperature Tb at which the resistance begins to increase comprises a range of −30° C. to 340° C. As higher amounts of impurities could impede the electrical features of the molded PTC-ceramic the content of the metallic impurities in the feedstock is lower than 10 ppm.

The metallic impurities in the feedstock may comprise Fe, Al, Ni, Cr and W. Their content in the feedstock, in combination with one another or each respectively, is less than 10 ppm due to abrasion from tools employed during the preparation of the feedstock.

The preparation of the feedstock comprises using tools having such a low degree of abrasion that a feedstock comprising less than 10 ppm of impurities caused by said abrasion is obtained. Thus, preparation of injection moldable feedstocks with a low amount of abrasion caused metallic impurities is achieved without the loss of desired electrical features of the molded PTC-ceramic.

The tools used for preparation of the feedstock comprise coatings of a hard material. The coating may comprise any hard metal, such as, for example, Tungsten Carbide (WC). Such a coating reduces the degree of abrasion of the tools when in contact with the mixture of ceramic filler and matrix and enables the preparation of a feedstock with a low amount of metallic impurities caused by said abrasion. Metallic impurities may be Fe, but also Al, Ni or Cr. When the tools are coated with a hard coating such as WC, impurities of W may be introduced into the feedstock. However, these impurities have a content of less than 50 ppm. It was found that in this concentration, they do not influence the desired electrical features of the sintered PTC-ceramic.

Where injection molding is used to form the mold, care must be taken regarding the metallic impurities in the mold to ensure that the efficiency of the PTC-ceramic is not reduced. The PTC-effect of ceramic materials comprises a change of the electric resistivity ρ as a function of the temperature T. While in a certain temperature range the change of the resistivity ρ is small with a rise of the temperature T, starting at the so-called Curie-temperature T_{c} the resistivity ρ rapidly increases with a rise of temperature. In this second temperature range, the temperature coefficient, which is the relative change of the resistivity at a given temperature, can have a value of 100%/K. If there is no rapidly increase at the Curie-temperature the self regulating property of the mold is unsatisfactory.

Features of the injection molded molding for heating a fluid are shown in more detail with the following detailed description when considered in conjunction with the accompanying drawings.

### BRIEF DESCRIPTION OF THE DRAWINGS

FIG. 1 is a view of a first embodiment of a ceramic PTC heater;

FIG. 2 is a view of a second embodiment of a ceramic PTC heater;

FIG. 3 is a view of a third embodiment of a ceramic PTC heater;

FIG. 4 is a view of a fourth embodiment of a ceramic PTC heater;

FIG. 5 is a view of a fourth embodiment of a ceramic PTC heater of FIG. 4 from another perspective; and

FIG. 6 is a view of a fifth embodiment of a ceramic PTC heater.

### DETAILED DESCRIPTION

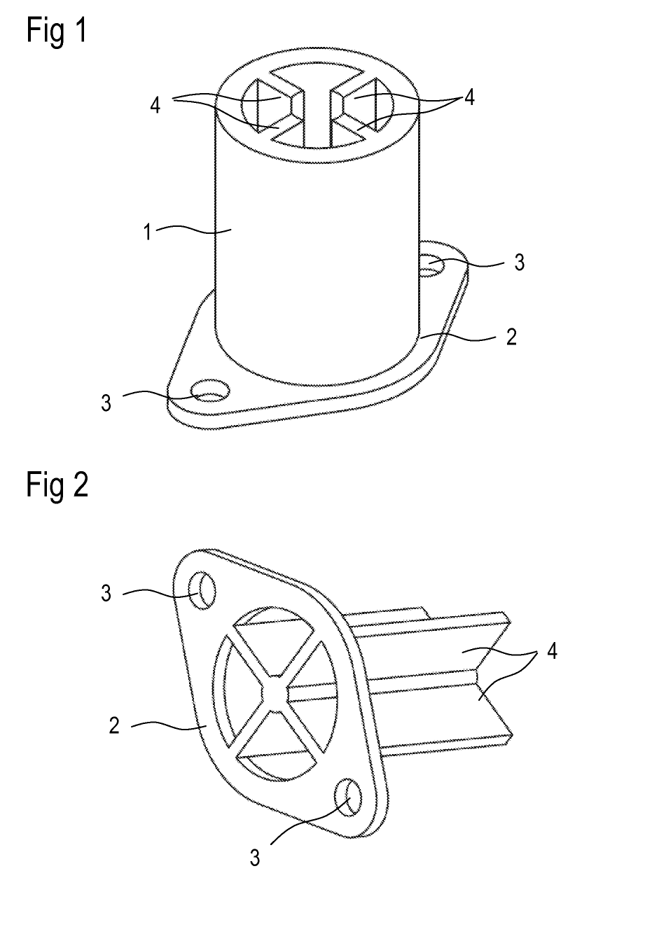

FIG. 1 is a perspective view showing an embodiment of a ceramic PTC heater used for heating fluids. The ceramic PTC heater of FIG. 1 shows a main tubular body 1 which comprises a least one flange 2 on one end of the tubular body. The flange 2 can also be located anywhere in lateral direction of the ceramic PTC heater. The flange 2 comprises two holes 3. The holes 3 can be used for fastening the ceramic PTC heater to a tube or something else. The flange 2 can comprise any number of holes 3, the flange 2 is not limited to two holes 3. The ceramic PTC heater shown in FIG. 1 may be used as a heating section for fluids circulating through a tube.

The tubular body 1 comprises one or more protrusions. In FIG. 1, the protrusion has the form of a fin 4. At least one fin 4 is placed inside the tubular body 1 of the ceramic PTC heater. The ceramic PTC heater shows four fins 4 inside the tubular body 1.

In another embodiment, the fins 4 inside the tubular body 1 can extend in a lateral direction, whereby the fins of the extended section can no longer be surrounded by a tubular body 1.

The first embodiment of the ceramic PTC heater shown in FIG. 1 is used for heating fluids such as gas or a liquid which circulate through the tubular body 1 of the ceramic PTC heater. The fins 4 inside the tubular section 1 offer a larger surface area for heating the fluid circulating along these fins 4.

The entire structure of the ceramic PTC heater is formed by injection molding of a ceramic PTC feedstock, e.g., in one single step. The ceramic PTC feedstock may contain less than 10 ppm (parts per million) of metallic impurities. Metallic impurities in ceramic PTCs affect the characteristics of the ceramic PTC in an unwanted manner.

Complex geometrical forms which cannot be formed by compression or extrusion molding can be formed by injection molding. Injection molded structures exhibit for every straight line through the injection molded molding at least two cross sectional areas perpendicular to this line, which cannot be superimposed on each other with a flush overlap by a translation along this line.

The ceramic PTC heater comprises at least one region comprising a conductive coating. The conductive coating may be used for electrically contacting of the ceramic PTC heater. The conductive coating can for example comprise Cr, Ni, Al, Ag or any other suitable material. For larger moldings the electric coating is advantageously applied on two opposite regions of the ceramic PTC heater.

It is advantageous for larger moldings to apply the electric coating on the inside and on the outside surface of the ceramic PTC heater. Heating effects may appear around regions of the electrically conductive coating. Thus, for larger moldings, like the one shown in FIG. 1, one electrical coating may be applied on the complete inside surface including the tubular body 1 and the fins 4 and another on the complete outer surface of the tubular body 1. For smaller moldings the electric coating can be applied as small strips on the surface of the ceramic PTC heater.

To obtain a protection of the ceramic PTC heater from corrosive or harmful substances, the surface of the molding, which is in contact to a fluid, may include a passivation coating. In an embodiment, the passivation coating comprises a corrosion protection. The corrosion protection can be carried out by a low melting glass or nano-composite lacquer coating, or by any other coating which protects the ceramic surface of the molding from the fluid circulating along or through the ceramic PTC heater. The nano-composite lacquer can comprise one or more of the following composites: SiO₂-polyacrylate-composite, SiO₂-polyether-composite, SiO₂-silicone-composite.

In another embodiment of the ceramic PTC heater, the fins inside the tubular body can be provided in a twisted shape to obtain a velocity of the fluid circulating through the ceramic PTC heater. Thus, a more effective heating of the fluid can be achieved. The twisted fins cause a turbulence of the fluid, which leads to a higher degree of efficiency of heat transfer from the ceramic PTC heater to the fluid.

FIG. 2 is a perspective view showing a second embodiment of a ceramic PTC heater. The ceramic PTC heater of FIG. 2 is designed to be placed into an external tube. The ceramic PTC heater comprises at least one flange 2 comprising a form similar to a cross according to the center of the cross-section. The cross is formed by the front face of four protrusions in form of fins 4. The fins 4 are arranged perpendicular to each other. The number of fins 4 is not limited to four fins. Any other number of fins 4 is possible.

The ceramic PTC heater comprises a least one flange 2, e.g., on one end of the ceramic PTC heater. The flange 2 can also be placed between the two ends of the ceramic PTC heater. Thus, the ceramic PTC heater can be placed between two tubes for heating of the fluid flowing through them.

It is also possible that the ceramic PTC heater comprises two flanges 2, one with a small cross section to fit inside a tube, and one bigger flange 2. The smaller flange 2 can be used for connecting the ceramic PTC heater inside a tube, and the bigger flange 2 for connecting on the outside of the tube. The flange 2 shown in FIG. 2 comprises two holes 3. The flange 2 can comprise any number of holes 3. The holes 3 can be used for connecting the ceramic PTC heater to another flange of a tube. The electrical contact of the ceramic PTC heater is achieved by an electrical coating that may be on the fins 4 of the PTC heater.

To obtain a protection of the ceramic PTC heater from corrosive or other harmful substances, the surface of the molding, which is in contact to a fluid, may include a passivation coating. The passivation coating comprises a corrosion protection which can for example be carried out by a glass coating, or by any other coating which protects the ceramic surface of the molding from the fluid circulating along or through the ceramic PTC heater.

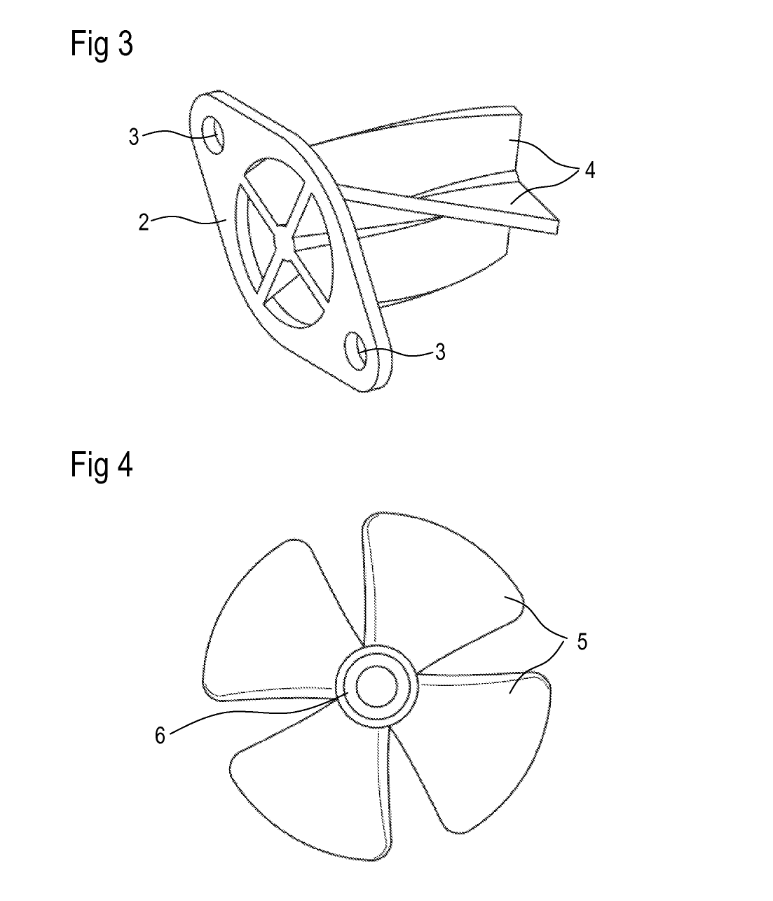

The third embodiment shown in FIG. 3 is similar to the second embodiment shown in FIG. 2. The fins 4 of the ceramic PTC heater are twisted similar to the thread of a screw. The fluid circulating along the fins 4 is vortexed by the twisted fins 4. Thus, a higher degree of efficiency of heat transfer from the ceramic PTC heater to the fluid is achieved. These complex geometrical forms may be formed by injection molding cannot be formed by extrusion molding. Injection molded complex geometrical structures obtain for every straight line through the injection molded molding at least two cross sectional areas perpendicular to this line, which cannot be superimposed on one another with a flush overlap by a translation along this line. At least one flange 2 with holes 3 can be placed at an end of the ceramic PTC heater or at a position between the ends.

The embodiment shown in FIG. 4 is a front view of a propeller shaped body. The body is formed of PTC ceramic by injection molding. The propeller comprises four protrusions in the form of blades 5 which are regularly arranged around a driving collar 6. The blades 5 may be swiveled backwards.

It is also possible that the propeller comprises a driving collar 6 with any reasonable number or form of protrusions. The propeller can comprise two, three, four, five or more blades 5 around the driving collar 6. The embodiment in FIG. 4 only shows a propeller with four blades 5, but almost any other quantity of blades 5 is possible. The backwards swiveled blades 5 cause a turbulent flow of the fluid circulating along the propeller. Thus, heat transfer with an high degree of efficiency and transport of the fluid can be achieved simultaneously. With a propeller of a ceramic PTC an efficient continuous heating of fluids can be obtained.

An electrical coating may be applied to the main surfaces of the propeller blades 5. Thus, a maximum area of the surface of the blades 5 can be used for heating the fluid. The electrical contacts are implemented by electrical coatings, which extend to the driving collar 6 of the propeller. The edge of the blades 5 may be devoid of an electrical coating. Thus, each blade 5 may act as one heating element by itself, with electrical coating on each side. The propeller may comprise a passivation coating for corrosion protection.

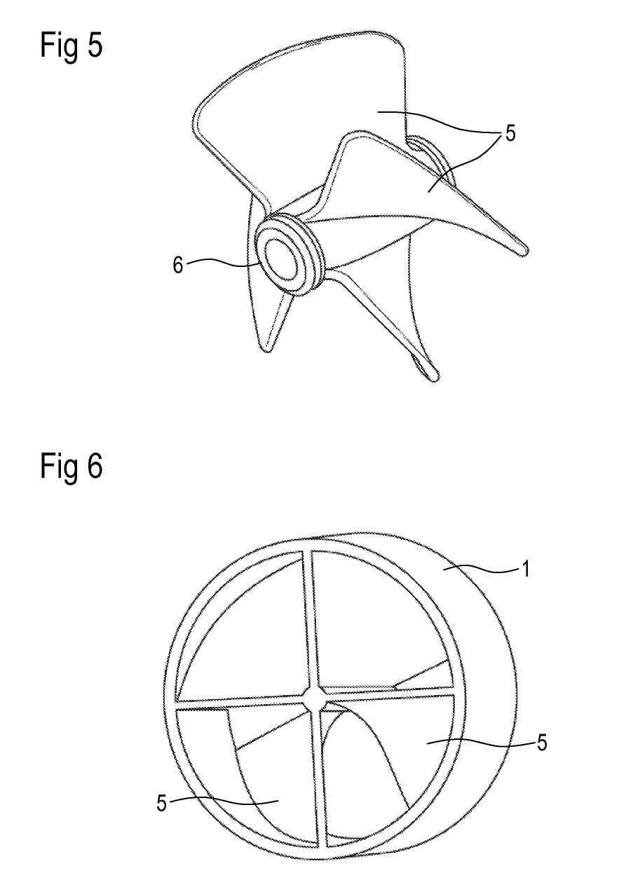

The embodiment in FIG. 5 is rotated in the perspective but otherwise corresponds to FIG. 4. The blades 5 of the propeller are arranged along the axis of the driving collar 6. The blades 5 are swiveled backwards to obtain a more effective heating and hauling of the air.

FIG. 6 is a perspective view showing a further embodiment of a ceramic PTC heater. The ceramic PTC heater in FIG. 6 has the form of a propeller. The propeller may be placed inside a tubular body 1 with a bearing on the outside of the tubular body 1. The blades 5 of the propeller are swiveled backwards to obtain a more efficient heating and transport of the fluid streaming through the molding. The ceramic PTC heater may be formed by injection molding.

The embodiment in FIG. 6 is also referred to as an impeller. Impellers are used within tubes or conduits to increase the pressure and flow of a fluid. Impellers are usually short cylinders with protrusions forming blades to push or propel the fluid and a splined center to accept a driveshaft. To work efficiently, there must be a close fit between the impeller and the housing. The housing can be a tube or conduit, in which the impeller is applied.

The embodiments described in FIG. 1 to FIG. 6 can be applied for heating of fluids within an air conditioning system of an automobile.

Other implementations are within the scope of the following claims. Elements of different implementations, including elements from applications incorporated herein by reference, may be combined to form implementations not specifically described herein.

What is claimed is:

1. A process for heating a fluid, comprising:
providing an injection molded molding comprising a ceramic material with a positive temperature coefficient containing less than 10 ppm of metallic impurities; and
using the injection molded molding to heat a fluid.

2. The process according to claim 1, wherein, for a straight line through the injection molded molding, at least two cross sectional areas perpendicular to the line cannot be superimposed on each other via a translation along the line.

3. The process according to claim 1, wherein a Curie-temperature is between 20° C. and 250° C.

4. The process according to claim 1, wherein a resistivity of the ceramic material at a temperature of 25° C. is in the range of 1 Ωcm to 500 Ωcm.

5. The process according to claim 1, wherein the ceramic material with a positive temperature coefficient comprises BaTiO₃.

6. The process according to claim 1, wherein the ceramic material with a positive temperature coefficient comprises
Ba_{1-x-y}MₓD_{y}Ti_{1-a-b}NₐMn_{b}O₃, wherein
x=0 to 0.5,
y=0 to 0.01;
a=0 to 0.01 and
b=0 to 0.01;
wherein M comprises a cation of the valency two, D comprises a donor of the valency three or four, and N comprises a cation of the valency five or six.

7. The process according to claim 1, wherein the fluid circulates along the injection molded molding.

8. The process according to claim 1, wherein the injection molded molding comprises at least one region comprising a conductive coating.

9. The process according to claim 8, wherein the at least one region comprises an electric contact.

10. The process according to claim 1, wherein at least surfaces of the injection molded molding circulated by fluid comprise a passivation coating.

11. The process according to claim 10, wherein the passivation coating comprises a corrosion protection.

12. The process according to claim 1, wherein the injection molded molding comprises ribs.

13. The process according to claim 1, wherein the injection molded molding comprises a cylindrical torso.

14. The process according to claim 1, wherein the injection molded molding comprises the form of a propeller.

15. The process according to claim 1, wherein the injection molded molding has a form of an impeller.

16. The process according to claim 1 or 15, wherein the fluid is vortexed.

17. The process according to claim 12 or 13, wherein the injection molded molding comprises at least one flange for a making connection.

18. An method for heating a fluid comprising:
the process according to claim 1;
wherein the injection molded molding is arranged within a cylindrical torso around which a fluid flows.

19. A process for heating an automobile, comprising the method of claim 18.

20. An injection molded molding comprising:
a ceramic material with a positive temperature coefficient containing less than 10 ppm of metallic impurities;
wherein, for a straight line through a body of the injection molded molding, at least two cross sectional areas perpendicular to the line cannot be superimposed on each other via a translation along the line; and
wherein parts of the injection molded molding can be circulated by a fluid.

21. The injection molded molding according to claim 20, comprising at least one protrusion.

22. The injection molded molding according to claim 21, wherein the protrusion has the form of a fin.

23. The injection molded molding according to claim 21, wherein the protrusion has a form of a blade.

24. The injection molded molding according to claim 21 to 23, wherein at least one part of the protrusion is surrounded by a tubular body.

25. The injection molded molding according to claim 20, wherein the injection molded molding has a form of a propeller having blades.

26. The injection molded molding according to claim 20, wherein the injection molded molding comprises a form of an impeller having blades.

27. The injection molded molding according to claim 25 or 26, wherein the blades are simultaneously used for heating and transport of fluid.
